(19) United States
(12) Patent Application Publication
(10) Pub. No.: US 2024/0212508 A1
(43) Pub. Date: Jun. 27, 2024

(54) Acquisition of Flight Information for UAV Communications

(71) Applicant: Telefonaktiebolaget LM Ericsson (publ), STOCKHOLM (SE)

(72) Inventors: Antonino Orsino, Kirkkonummi (FI); Helka-Liina Määttänen, Espoo (FI); Mattias Bergström, Sollentuna (SE); Hieu Do, Järfälla (SE)

(73) Assignee: Telefonaktiebolaget LM Ericsson (publ), STOCKHOLM (SE)

(21) Appl. No.: 18/568,027

(22) PCT Filed: May 24, 2022
(86) PCT No.: PCT/SE2022/050501

§ 371 Date: Dec. 7, 2023

Related U.S. Application Data
(60) Provisional application No. 63/197,715, filed on Jun. 7, 2021.

(51) Int. Cl. G08G 5/00

(52) U.S. Cl. CPC G08G 5/0013; G08G 5/0026

(57) ABSTRACT

Techniques, apparatuses, and systems for improving communications involving unmanned aerial vehicles, UAVs. An example method, in a user equipment, UE, in a UE-equipped unmanned aerial vehicle, UAV, comprises the steps of determining (710) that flight information for UAVs in the vicinity of the UE-equipped UAV is needed and sending (720), to a wireless communication system, a request for flight information, in response to said determining. The step of determining that flight information is needed might be based on any of the following, in various examples: the flight path of the UE-equipped UAV has changed; a configured timer has expired; a discovery signal sent by a neighbor drone is received; the UE has been handed over; interference measured by the UE has gone above a configured threshold; and a channel quality measured by the UE has gone below a configured threshold.

### TECHNICAL FIELD

The present disclosure is generally related to wireless communications networks and is more particularly related to communications involving user equipments (UEs) associated with unmanned aerial vehicles (UAVs).

### BACKGROUND

UAV communications in 3GPP

The world is witnessing a widespread and increasing use of drones, or, more technically, Unmanned Aerial Vehicles (UAV), in many segments of the economy and in our daily life. There are numerous use cases for UAVs in industry, goods transportation and delivery, surveillance, media production, etc.

Traditionally, the UAVs can only be flown by a controller within a visual line of sight (VLoS). Realizing the great potential of connecting drones beyond visual line of sight (BVLoS), via a cellular network, members of the 3rd-Generation Partnership Project (3GPP) have specified multiple features in LTE Rel-15, aiming at improving the efficiency and robustness of terrestrial LTE network for providing aerial connectivity services, particularly for low altitude UAVs. These features target both command-and-control traffic for flying the drone and the data (also known as payload) traffic from the drone to the cellular network. Key features specified include:
Support for subscription-based identification
Height reporting when UAV crosses a height threshold. The report includes height, location (3D), horizontal and vertical speed.
Reference Signal Received Power (RSRP) or Reference Signal Received Quality (RSRQ) reporting per event of N cells' signal power above a threshold. The report includes RSRP/RSRQ/location(3D).
UE-specific uplink (UL) power control.
Flight path information provided from UE to eNB. This includes network polling and list of waypoints (3D location), time stamp if available.

These features were introduced to target special needs when serving the UAVs by LTE network, e.g., the need for flying mode detection, interference detection, and interference mitigation. The first important issue was flying mode detection, which is also related to interference detection, as the interference conditions for flying aerial UEs are different from aerial UE in terrestrial mode. For interference detection, which may also serve as input to flying mode detection, an enhancement to existing events triggering of RSRP/RSRQ/RS-SINR reports was introduced in LTE Rel-15. The UE may be configured to trigger an event such as A3, A4, A5, which all consider neighbor cell measurements. In such event triggers, a measurement report is triggered when multiple cells' measured RSRPs (RSRQs/RS-SINRs) are above a threshold.

Another input to flying mode detection is event-triggered height and location reporting. A new configurable event within Radio Resource Management (RRM) with height threshold is introduced for Rel-15 Aerial UEs. When the UE is configured with an event, a report is triggered when UE's altitude crosses the threshold altitude. In addition to flying mode detection, the exact height information is considered useful as the network may choose to reconfigure, for example, measurement reporting configurations for the UE when it crosses a height threshold. FIG. 1 depicts this situation, showing a network (e.g., the E-UTRAN) reconfiguring an aerial UE based on flying altitude. In this figure, when the UE is below a height of 100 m, the aerial UE is RRC configured with measurement reporting configurations and event-triggered height/location reporting corresponding to a height threshold of 200 m. As the aerial UE crosses a height threshold of 200 m, a report is trigged from the UE to the network. After receiving the report from the aerial UE, the network RRC reconfigures the aerial UE with new measurement reporting configurations.

### Sidelink Communications

3GPP has specified an LTE D2D (device-to-device) technology, also known as the sidelink (SL) or the PC5 interface, as part of Release 12 (Rel-12). The target use case (UC) was Proximity Services, ProSe, covering both communication and discovery. The design was enhanced during Rel-13. In Rel-14, the LTE SL was extensively redesigned to support vehicular communications (commonly referred to as V2X) for road-safety applications and some further enhancements were specified during Rel-15. From the point of view of the lowest radio layer (PHY layer), the LTE SL uses broadcast communication, i.e., the transmission from a transmitter UE targets all receiver UEs in its proximity.

In Rel-16, 3GPP introduced the sidelink for the 5G new radio (NR). The driving UCs were advanced V2X UCs (e.g., cooperative driving or sensor sharing) with more stringent requirements than those typically served using the LTE SL. To meet these requirements, the NR SL was designed to support both broadcast, groupcast, and unicast communications at PHY layer. Notably, hybrid automatic repeat request (HARQ) feedback was introduced for SL groupcast and unicast.

Both LTE SL and NR SL can operate with and without network coverage and with varying degrees of interaction between the UEs (user equipment) and the NW (network), including support for network-less operation.

In the ongoing Rel-17, 3GPP is working on enhancements to the NR SL. The ambition is not only to improve the capabilities of NR SL for V2X but also to address other UCs such as National Security and Public Safety (NSPS) as well as commercial UCs such as Network Controlled Interactive Services (NCIS). In particular, inter-UE coordination in resource allocation is being specified to improve the reliability of SL communications, whereas SL discontinuous reception (SL-DRX) and partial resource sensing are being specified for power/energy saving purposes.

There are two resource allocation modes in SL. In the first mode, SL transmissions by the UEs are scheduled by a network node (e.g., eNB or gNB), i.e., the network node grants the SL resources to the UEs. This network-scheduled mode is often referred to as Mode 1 in NR SL Rel-16 and as Mode 3 in LTE SL Rel-14. In the second mode, UEs autonomously find resources for their SL transmissions in a set of resources configured by the network or preconfigured, often referred to as SL resource pool. This mode of resource allocation is referred to as Mode 2 in in NR SL Rel-16 and as Mode 4 in LTE SL Rel-14. In the latter mode, each UE typically tries to decode control information sent by the other UEs and measures interference level on different resource units to find the most suitable resources for the UE's transmissions, a process often referred to as resource sensing.

### Sidelink Communications for UAVs

There is a growing interest in the telecom industry to enhance the 5G NR standards to support UAV communication. This includes serving the UAVs as aerial-UEs via uplink and downlink (i.e., the Uu interface) and supporting direct communication between UAVs (i.e., via the PC5 interface). The latter is considered useful for the collision Detection and Avoidance (D/A) use cases, for example, whereby the UAVs are able to detect the presence of one another and to react to avoid collisions. In fact, 3GPP has taken these demands into account when setting the requirements for Remote Identification of UAS in 3GPP TS 22.125 V17.3.0 (March 2021), as can be seen in the following excerpt from that standards document:

### 5.2.2 Decentralized UAS [Unmanned Aircraft System] Traffic Management

[R-5.2.2-001] The 3GPP system shall enable a UAV to broadcast the following data for identifying UAV(s) in a short-range area for collision avoidance: e.g. UAV identities if needed based on different regulation requirements, UAV type, current location and time, flight route information, current speed, operating status.
[R-5.2.2-002] The 3GPP system shall be able to support a UAV to transmit a message via network connection for identifying itself as an UAV to the other UAV(s).
[R-5.2.2-003] The 3GPP system shall enable UAV to preserve the privacy of the owner of the UAV, UAV pilot, and the UAV operator in its broadcast of identity information.
[R-5.2.2-004] The 3GPP system shall enable a UAV to receive local broadcast communication transport service from other UAV in short range.
[R-5.2.2-005] A UAV shall be able to use a direct UAV to UAV local broadcast communication transport service in the coverage or out of coverage of a 3GPP network.
[R-5.2.2-006] A UAV shall be able to use a direct UAV to UAV local broadcast communication transport service when the sending and receiving UAVs are served by the same or different PLMNs.
[R-5.2.2-007] The 3GPP system shall support a direct UAV to UAV local broadcast communication transport service at relative speeds of up to 320 kmph.
[R-5.2.2-008] The 3GPP system shall support a direct UAV to UAV local broadcast communication transport service with variable message payloads of 50-1500 bytes, not including security-related message component(s).
[R-5.2.2-009] The 3GPP system shall support a direct UAV to UAV local broadcast communication transport service which supports a range of up to 600 m.
[R-5.2.2-010] The 3GPP system shall support a direct UAV to UAV local broadcast communication transport service which can transmit messages at a frequency of at least 10 messages per second.
[R-5.2.2-011] The 3GPP system shall support a direct UAV to UAV local broadcast communication transport service which can transmit messages with an end-to-end latency of at most 100 ms.

In summary, it is required that the 3GPP system support the broadcasting of UAV identity and other information related to UAV's speed and route over the PC5 interface for the purpose of collision detection and avoidance. Moreover, the UAV-to-UAV communication over PC5 should be able to support regularly broadcasted messages with certain payload size and latency requirements, both in network coverage and out of network coverage.

### Unmanned Aircraft Systems (UAS) Traffic Management (UTM)

It is of utmost importance to keep the airspace safe and accessible. Therefore, a system called UTM is being developed in different parts of the world to manage the traffic of the UAS (a UAS is composed of a UAV and a UAV controller used by an operator with unique credentials and identities.) According to NASA, UTM is a collaborative, automated, and federated airspace management approach that enables safe, efficient, and equitable small UAS operations at scale. The concept of UTM is being adopted and implemented by many countries and regions in the world, e.g., in the US, Europe, Japan, Australia, etc.

### According to Reference [1], the UTM Provides Many Flight-Related Functions for UAVs and UAV Operators, for Example:

Remote identification: enabling UAV identification.
Operation planning: flight planning considering various aspects e.g., UAV performance, whether condition.
Operator messaging: message exchange between operators for e.g., position and status information.
FAA messaging: providing on-demand, periodic, or event-triggered communications with FAA systems to meet regulatory requirements.
Mapping: information about airspace restrictions, obstacles, and sensitive regions.
Conflict advisory: real-time alerting for collision avoidance.

Mobile networks can enable reliable connectivity between the UAV and its controller. Meanwhile, UTM can connect to the UAV and the UAV controller through the core network and the radio access network. An illustration of UAS-to-UTM connectivity is provided in FIG. 2.

There currently remain certain challenges.

### SUMMARY

During standardization discussions regarding UAV communication, it emerged that the topic of collision detection and avoidance is of interest and is proposed to be addressed during the 3GPP normative work. However, while the regular broadcasting messages for collision detection and avoidance (D/A) over sidelink transmissions by the UAVs, as required by SA1, appear to resemble the regular broadcasting of traffic-safety messages for V2X, which drove the design of LTE SL Rel-14 (and was also fulfilled by NR SL Rel-16), there is an important factor that may affect the reuse of the existing sidelink for UAV. In fact, a fundamental assumption is that the flight information of other UEs (e.g., deployed in different cells, different core network, and by different mobile operators) are known at the 3GPP network.

But, at the moment there is no interface that is capable to connect existing Unmanned Aircraft Systems (UAS) and Unmanned Traffic Management (UTM) network with the current 3GPP system. Without a proper connection between these two networks, it is not possible for the radio access network (RAN) to acquire all the necessary information in order to configure a proper detection and avoidance service at the drone UE. This basically means that the detection and avoidance feature may not work in practice.

Certain aspects of the disclosure and their embodiments may provide solutions to these or other challenges. These solutions allow the 3GPP system (e.g., NR or LTE) to communicate and interact with existing Aircraft Systems (UAS) and Unmanned Traffic Management (UTM) networks. This can be according to any of the following solutions:
A new or an existing entity hosted at the 3GPP CN is used to work as a “bridge” between the 3GPP network and one (or more) existing UAV traffic systems.
Given that the 3GPP system and one (or more) existing UAV traffic systems are able to communicate each other's, in order to achieve the flight information of other UE the following approaches may be used:
   NW-triggered acquisition of flight information related to drone UE. The network understands (e.g., based on the UE reports) that new flight information is needed and queries such information to one (or more) existing UAV traffic systems.
   UE-triggered acquisition of flight information related to drone UE. The UE understands itself that new flight information is needed and sends an indication to the network (that queries such information to one (or more) existing UAV traffic systems).

Thus, embodiments described herein include an example method, in a UE in a UE-equipped UAV, where the method comprises the steps of determining that flight information for UAVs in the vicinity of the UE-equipped UAV is needed and sending, to a wireless communication system, a request for flight information, in response to said determining. The step of determining that flight information is needed might be based on any of the following, in various examples: the flight path of the UE-equipped UAV has changed; a configured timer has expired; a discovery signal sent by a neighbor drone is received; the UE has been handed over; interference measured by the UE has gone above a configured threshold; and a channel quality measured by the UE has gone below a configured threshold.

Another example method, according to some of the embodiments described herein, is carried out by a network node of a wireless communication system. This example method also comprises determining that flight information for UAVs in the vicinity of a UE-equipped UAV is needed, but further comprises sending, towards a node external to the wireless communication system, a request for flight information, in response to said determining.

Corresponding apparatuses and systems are also detailed herein.

Advantages applicable to several of the solutions described herein is that they help achieve a 3GPP network to communicate and exchange information, about UE flight information, with one (or more) existing UAV traffic systems. This will help the 3GPP network to acquire all necessary flight information of other UEs (e.g., deployed in different cells, different core network, and by different mobile operators) and configure UAV features accordingly. This means also that it would be possible to, e.g., have a good trade-off between maximizing the utility of UAV communication and minimizing the energy consumption at the UAVs.

### BRIEF DESCRIPTION OF THE FIGURES

FIG. 1 illustrates a scenario where the network is reconfiguring an aerial UE based on its flying altitude.

FIG. 2 shows UAS-to-UTM connectivity.

FIG. 3 shows example network architecture for connecting the UTM network to the 3GPP network.

FIG. 4 is a signal-flow diagram illustrating network-triggered acquisition of flight information related to a UE-equipped UAV.

FIG. 5 is another signal-flow diagram, illustrating UE-triggered acquisition of flight information related to a UE-equipped UAV.

FIG. 6 is a process flow diagram illustrating an example method in a network node, according to some embodiments.

FIG. 7 is a process flow diagram illustrating an example method in a UE, according to some embodiments.

FIG. 8 illustrates an example communication system.

FIG. 9 is a block diagram illustrating features of an example UE.

FIG. 10 illustrates an example network node.

FIG. 11 is a block diagram of a host.

FIG. 12 is a block diagram illustrating a virtualization environment.

FIG. 13 shows a communication diagram of a host communicating via a network node with a UE over a partially wireless connection.

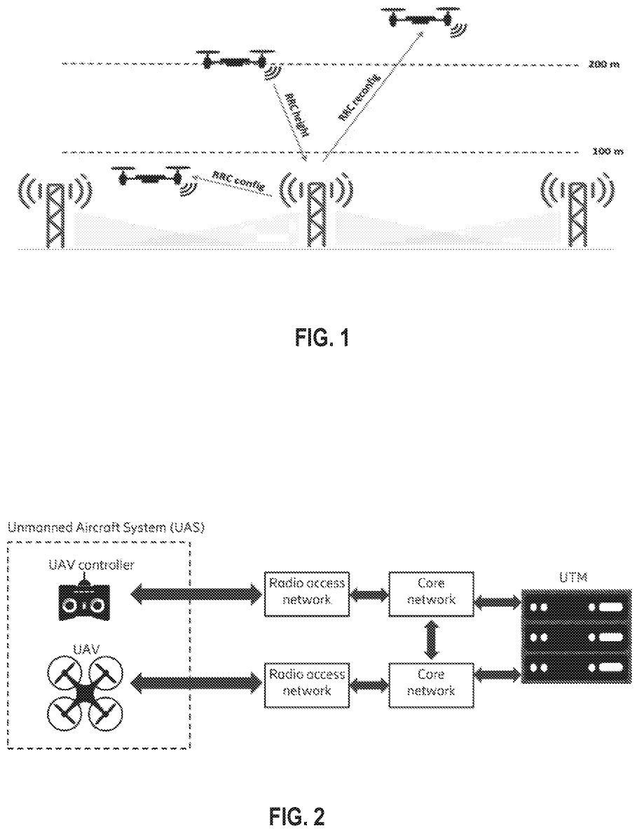

### DETAILED DESCRIPTION

Some of the embodiments contemplated herein will now be described more fully with reference to the accompanying drawings. Embodiments are provided by way of example to convey the scope of the subject matter to those skilled in the art.

Some of the embodiments contemplated herein will now be described more fully with reference to the accompanying drawings. Embodiments are provided by way of example to convey the scope of the subject matter to those skilled in the art.

In this section we use the term UE to denote the aerial UEs, i.e., the UAVs which are categorized as UEs in cellular networks. The term “drone UE” should be understood as referring to a UE-equipped UAV.

The proposed solutions are presented in the context of UEs broadcasting messages for detection and avoidance (D/A) but can be equally applied to other type of use cases such as UEs broadcasting ID-related messages for UE identification.

Some solutions below are applicable to both LTE SL and NR SL. Some are applicable to NR SL only.

An assumption here, applicable to some embodiments, is that at least some flight path information of UEs is stored on an entity/network that is outside of the 3GPP network. A possible example of this “external” entity is represented by the UAS Traffic Management (UTM) system.

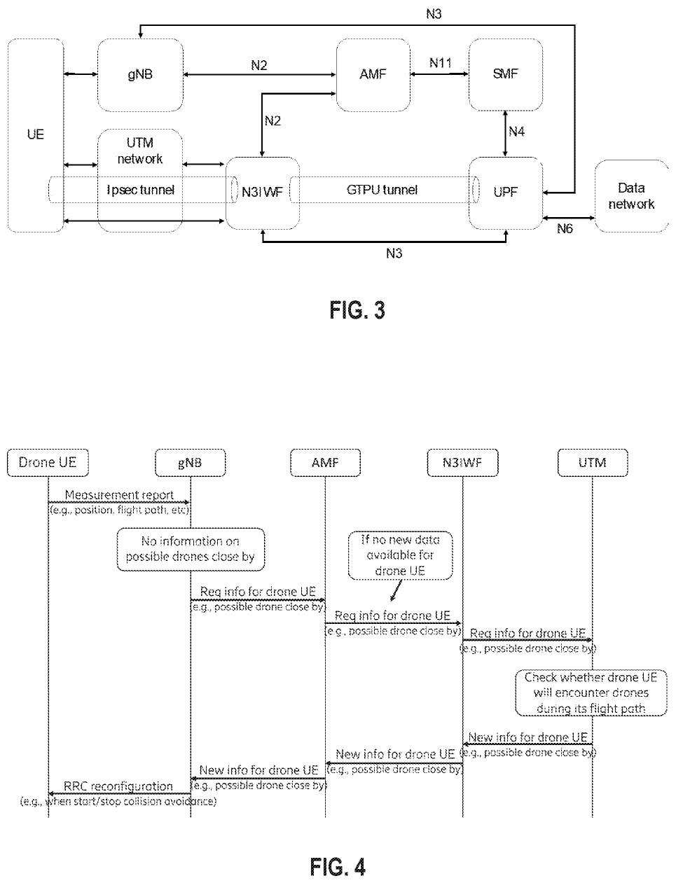

According to this, an aspect that should be considered is how this external entity is connected to the 3GPP network so that flight path (but also other information related to flight) of UE is known by the 3GPP RAN, CN, and/or UE. To do this, in some embodiments the external entity/network (where flight paths and other information of drone UE are stored) is connected to the 3GPP network via the 3GPP N3IWF block. Yet, in another embodiment, the external entity is connected to the 3GPP network via a new 3GPP entity hosted at the 3GPP CN. An example of the architecture connecting the UTM network with the 3GPP network is depicted in FIG. 3.

In some embodiments, the main functionalities of this new CN block or N3IWF block are to create a secure transmission between the 3GPP network and a non-3GPP one. Such new functionalities may include at least one of the following:
Sending/receiving control plane messages with the 3GPP AMF.
Sending/receiving user place messages with the 3GPP UPF.
Translating packets coming from the external entity/network in the 3GPP PDU and SDU format, and vice versa.
Acting as a central authority in case a certain functionality should activated/disactivated at the drone UE and, in case, generate the related configuration.
Establishing a secure connection between the external entity/network and the 3GPP network.

Once a secure connection is established between the external entity/network (e.g., the UTM network) and the 3GPP network, a further issue to be addressed is how the UE obtains a configuration about when to use the collision avoidance service, or how the UE obtains information on whether there are other drones close by. According to what is illustrated in FIG. 4, which illustrates network-triggered acquisition of flight information related to a drone UE, or UE-equipped UAV, in one embodiment the drone UE send a measurement report to the gNB by informing e.g., its position, its (new) flight path and channel measurement such as RSRP, RSRQ, SINR, and/or RSSI. Based on the information received by the UE, the gNB may understand on whether a change on the current UE configuration (e.g., when to start/stop the D/A transmission) is needed. If this is the case, the gNB may send a request to the AMF to ask new flight info (whether the UE will have other drones close by in certain location of its flight path) for the drone UE.

If the AMF has already updated information about the drone UE, it can directly send such information to the gNB. Otherwise, if no updated information is available for the drone UE, the AMF sends a request to the new CN block (or N3IWF) to acquire new flight info for the drone ID and the CN block (or the N3IWF) will forward this request to the external entity/network (e.g., the UTM).

Once that the external entity/network (e.g., the UTM) send the information to the new block (or N3IWF), these are sent back to the gNB via the AMF. The gNB can then generate a new RRC configuration and send it to the UE in order to configure the UE on when to start/stop the D/A transmissions.

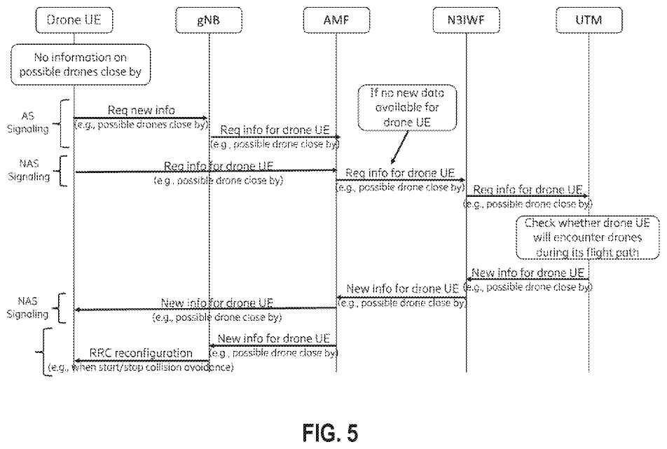

In some embodiment, the acquisition of the flight information for a certain UE is triggered by the UE itself. As shown in FIG. 5, which illustrates UE-triggered acquisition of flight information related to a drone UE, the drone UE may decide to ask for updated flight information. This may happen when at least one of the following criteria is met, for example:
The flight path of the UE has changed
When a configured timer has expired
Upon the reception of a discovery signal sent by a neighbor drone
Upon handover
When the interference goes above a configured threshold
When the channel quality (measurement by RSRP, RSRQ, SINR, and/or RSSI) goes below a configured threshold.

Once the UE decides to ask for updated flight information, the request may be sent by using access stratum (AS) signaling (i.e., the request is sent to the gNB) or non-access stratum (NAS) signaling (i.e., the request is sent to the AMF). Similarly to the NW-triggered approach illustrated in FIG. 4, if the AMF has already updated information about the drone UE, it can directly send such information to the gNB. Otherwise, if no updated information are available for the drone UE, the AMF sends a request to the new CN block (or N3IWF) to acquire new flight info for the drone ID and the CN block (or the N3IWF) will forward this request to the external entity/network (e.g., the UTM).

In some embodiments, each UE reports its own flight path (and/or flight path information it has received from other drones) to its serving gNB. Once the serving gNB has received it, the serving gNB shares this information with other gNB by using the SON/MDT framework. When sharing information among gNBs, this can be done by using the X2/Xn signalling or inter-node RRC messages. How the UE decides to report its own (of from other drones) flight path information may be done when at least one of the following criteria are met, for example:
The flight path of the UE has changed
When a configured timer has expired
Upon handover
Upon a request from the network
When a flight path of a neighboring drone is acquired (e.g., via PC5)
Certain criteria when UE is allowed to update network about change in flight path.

The last item in the list above is to allow UEs to send only critical updates to the network and diminish uplink interference from constant updates that are not necessarily needed. For example, the criterion for sending information may be that a collision risk is detected. Alternatively, the UE may inform the network that there has been a change in flightpath information of its own or for a neighboring drone, and then the network may decide if it needs to ask for an update.

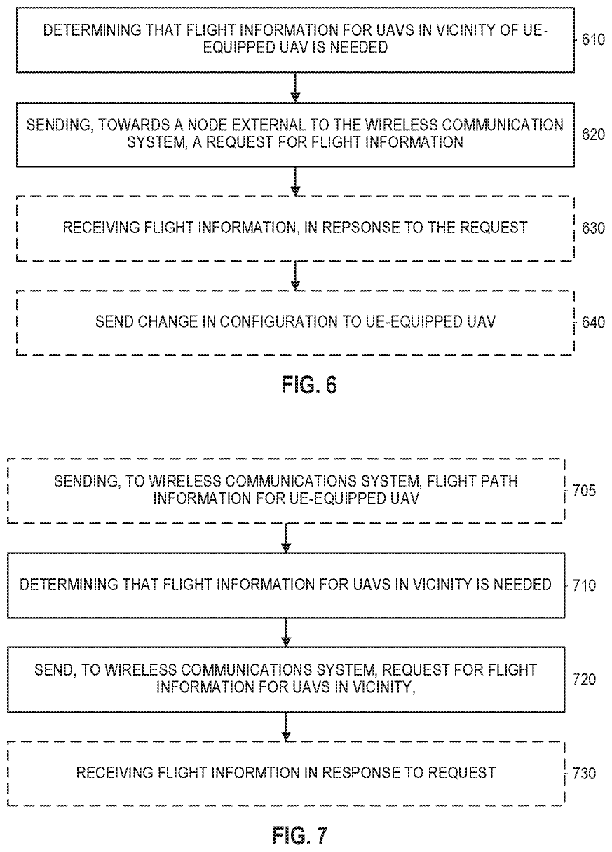

FIG. 6 illustrates a process flow diagram for a generalized method, as carried out in a network node in or connected to a wireless communication system, for carrying out one or several of the techniques described above. In various embodiments, the network node is serving a user equipment (UE) associated with a unmanned aerial vehicle (UAV), although it should be appreciated that the specific techniques describe herein may be applied more generally than that. The illustrated method, and the several variations described below, should be understood as encompassing and/or complementing the techniques described above, such that any of the variations described above are applicable to the method of FIG. 6, and vice versa. Furthermore, multiple ones of the numerous variations described herein may be implemented in and/or carried out by the same network node, in some embodiments.

As shown at block 610, the method comprises determining, at the network node, determining that flight information for unmanned aerial vehicles (UAVs) in the vicinity of a UE-equipped UAV is needed. As shown at block 620, the method may further comprise sending, towards a node external to the wireless communication system, a request for flight information, in response to said determining. Note that sending “towards” a node means that the request is sent in the direction of the node—the request may pass through one or more intermediate nodes before reaching the targeted node.

In some embodiments, the network node is a base station serving the UE-equipped UAV, and the request is sent to an Access and Mobility Management Function (AMF) in the wireless communication system. In some embodiments, determining that the flight information is needed is based on information reported to the base station by the UE-equipped UAV. This information reported to the base station by the UE-equipped UAV may comprise any one or more of any of the following, for example: position information for the UE-equipped UAV; measurement information; and flight path information for the UE-equipped UAV.

In some embodiments or instances, the network node is an AMF, in the wireless communication system, and said determining that flight information is needed comprises receiving a request for said flight information from a base station serving the UE-equipped UAV. In some embodiments or instances, the network node sends the request for flight information to a network interworking function, for forwarding to the node external to the wireless communication system. In some other embodiments or instances, the network node sends flight information already possessed by the network node to the base station, in response to the request.

In other embodiments or instances, the network node is a network interworking function in the wireless communication system, and said determining that flight information is needed comprises receiving a request for said flight information from an AMF in the wireless communication system. In some of these embodiments or instances, the network node sends the request for flight information to the node external to the wireless communication system. The method shown in FIG. 6 may further comprise receiving, in response to the request, flight information for UAVs in the vicinity of the UE-equipped UAV. This is shown at block 630. This information might, for example, indicate a flight path for each one or more UEs, indicate UE density in a geographical area corresponding to the vicinity of the UE, indicate uplink interference caused by one or more UEs, and/or indicate a speed for one or more UEs.

In some of these embodiments, the network node is a base station serving the UE-equipped UAV, and the flight information is received from an AMF. In some of these embodiments, the method may further comprise sending a change in configuration to the UE-equipped UAV, based on the flight information, as shown at block 640; this change in configuration may indicate a change in transmission or reception of detection and avoidance messages by the UE-equipped UAV, for example.

In other embodiments or instances, the network node is an AMF and the flight information is received from a network interworking function. In these embodiments, the method may further comprise forwarding the flight information to a base station serving the UE-equipped UAV.

In still other embodiments or instances, the network node is a network interworking function in the wireless communication system, and the flight information is received from the node external to the wireless communication system. In these embodiments, the method may further comprise forwarding the flight information to an AMF.

FIG. 7 illustrates a method as might be carried out in UE, in a UE-equipped UAV, corresponding to several of the techniques described above. As shown at block 710, the method comprises the step of determining that flight information for UAVs in the vicinity of the UE-equipped UAV is needed. As shown at block 720, the method comprises sending, to a wireless communication system, a request for flight information, in response to said determining.

This determining that flight information is needed may be based on one or more of any of the following, in some embodiments or instances: the flight path of the UE-equipped UAV has changed; a configured timer has expired; a discovery signal sent by a neighbor drone is received; the UE has been handed over; interference measured by the UE has gone above a configured threshold; and a channel quality measured by the UE has gone below a configured threshold.

In some embodiments or instances, the request is sent towards an AMF, using non-access stratum (NAS) signaling.

In some embodiments or instances, the method further comprises receiving, in response to the request, flight information for UAVs in the vicinity of the UE-equipped UAV. This is shown at block 730 of FIG. 7.

In some embodiments, the method may comprise sending, to the wireless communications system, flight path information for the UE-equipped UAV. This is shown at block 705, and may be in conjunction with or separately from the other steps shown in FIG. 7. In some of these embodiments or instances, this sending of flight path information for the UE-equipped UAV is triggered by one or more of any of the following, for example: the flight path of the UE-equipped UAV has changed; a configured timer has expired; a discovery signal sent by a neighbor drone is received; the UE has been handed over; a request from the wireless communications network; interference measured by the UE has gone above a configured threshold; and a channel quality measured by the UE has gone below a configured threshold.

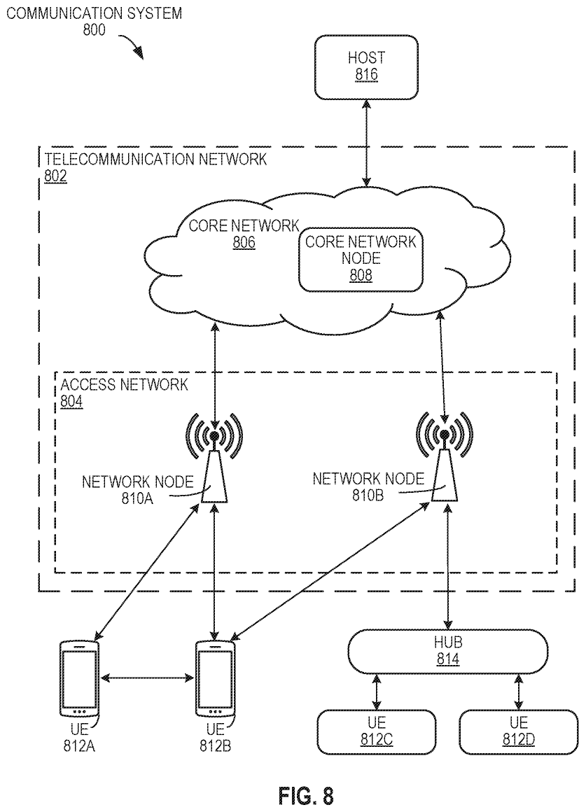

FIG. 8 shows an example of a communication system 800 in accordance with some embodiments.

In the example, the communication system 800 includes a telecommunication network 802 that includes an access network 804, such as a radio access network (RAN), and a core network 806, which includes one or more core network nodes 808. The access network 804 includes one or more access network nodes, such as network nodes 810a and 810b (one or more of which may be generally referred to as network nodes 810), or any other similar 3rd Generation Partnership Project (3GPP) access node or non-3GPP access point. The network nodes 810 facilitate direct or indirect connection of user equipment (UE), such as by connecting UEs 812a, 812b, 812c, and 812d (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 814 communicates with the access network 804 to facilitate indirect communication between one or more UEs (e.g., UE 812c and/or 812d) and network nodes (e.g., network node 810b). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810b. In other embodiments, the hub 814 may be a non-dedicated hub—that is, a device which is capable of operating to route communications between the UEs and network node 810b, but which is additionally capable of operating as a communication start and/or end point for certain data channels.

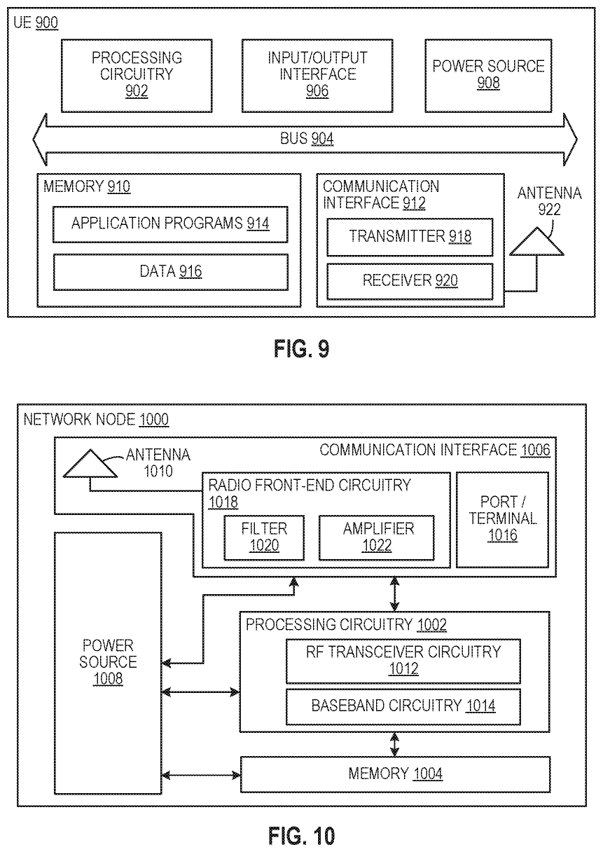

FIG. 9 shows a UE 900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In the illustrated embodiment, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node 1000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes a processing circuitry 1002, a memory 1004, a communication interface 1006, and a power source 1008. The network node 1000 may be composed of multiple physically separate components (e.g., a NodeB component and a RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, to provide network node 1000 functionality.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

FIG. 11 is a block diagram of a host 1100, which may be an embodiment of the host 816 of FIG. 8, in accordance with various aspects described herein. As used herein, the host 1100 may be or comprise various combinations hardware and/or software, including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 9 and 10, such that the descriptions thereof are generally applicable to the corresponding components of host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for over-the-top services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

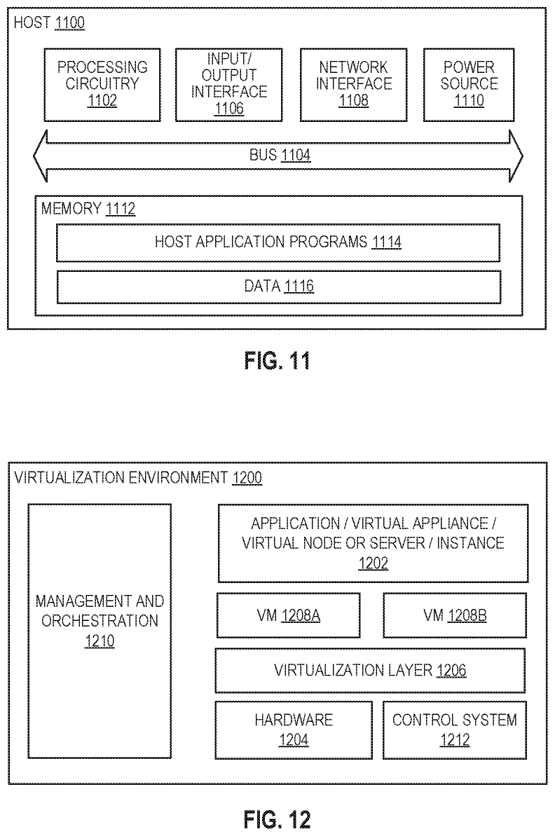

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g. such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

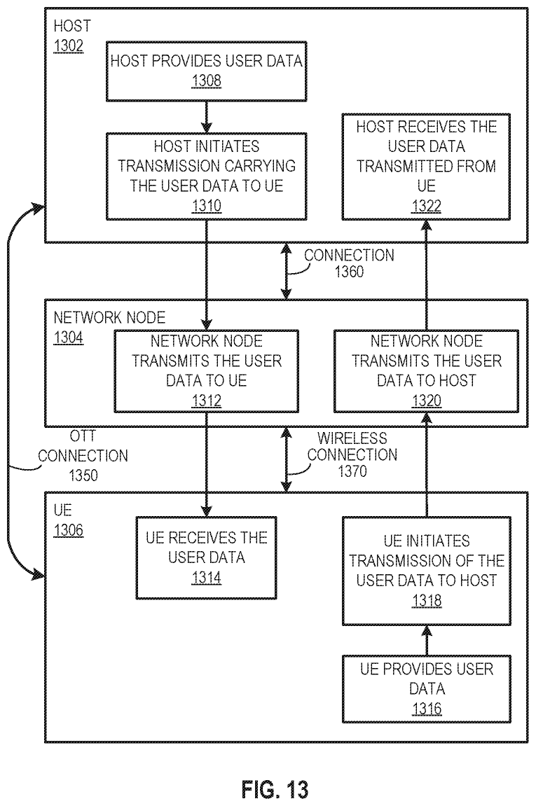

FIG. 13 shows a communication diagram of a host 1302 communicating via a network node 1304 with a UE 1306 over a partially wireless connection in accordance with some embodiments. Example implementations, in accordance with various embodiments, of the UE (such as a UE 812a of FIG. 8 and/or UE 900 of FIG. 9), network node (such as network node 810a of FIG. 8 and/or network node 1000 of FIG. 10), and host (such as host 816 of FIG. 8 and/or host 1100 of FIG. 11) discussed in the preceding paragraphs will now be described with reference to FIG. 13.

Like host 1100, embodiments of host 1302 include hardware, such as a communication interface, processing circuitry, and memory. The host 1302 also includes software, which is stored in or accessible by the host 1302 and executable by the processing circuitry. The software includes a host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the teachings of these embodiments may improve the efficiency and operation of a UE-equipped UAV, and in particular may improve its power consumption, which may in turn provide for more reliable and timely communications to and from the UE-equipped UAV.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306. In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EMBODIMENTS

Embodiments of the presently disclosed techniques, apparatuses, and systems include, but are not limited to, the following examples.

### Group a Embodiments

1. A method, in a user equipment, UE, in a UE-equipped unmanned aerial vehicle, UAV, the method comprising:
   determining that flight information for UAVs in the vicinity of the UE-equipped UAV is needed; and
   sending, to a wireless communication system, a request for flight information, in response to said determining.
2. The method of example embodiment 1, wherein said determining is based on one or more of any of:
   the flight path of the UE-equipped UAV has changed;
   a configured timer has expired;
   a discovery signal sent by a neighbor drone is received;
   the UE has been handed over;
   interference measured by the UE has gone above a configured threshold; and
   a channel quality measured by the UE has gone below a configured threshold.
3. The method of example embodiment 1 or 2, wherein the request is sent towards an Access and Mobility Management Function, AMF, using non-access stratum, NAS, signaling.
4. The method of any one of example embodiments 1-3, further comprising:
   receiving, in response to the request, flight information for UAVs in the vicinity of the UE-equipped UAV.
5. The method of any one of example embodiments 1-4, further comprising:
   sending, to the wireless communications network, flight path information for the UE-equipped UAV.
6. The method of example embodiment 5, wherein sending flight path information for the UE-equipped UAV is triggered by one or more of any of:
   the flight path of the UE-equipped UAV has changed;
   a configured timer has expired;
   a discovery signal sent by a neighbor drone is received;
   the UE has been handed over;
   a request from the wireless communications network;
   interference measured by the UE has gone above a configured threshold; and
   a channel quality measured by the UE has gone below a configured threshold.
7. The method of any of the previous embodiments, further comprising:
   providing user data; and
   forwarding the user data to a host via the transmission to the network node.

### Group B Embodiments

8. A method, in a network node of a wireless communication system, the method comprising:
   determining that flight information for unmanned aerial vehicles, UAVs, in the vicinity of a UE-equipped UAV is needed; and
   sending, towards a node external to the wireless communication system, a request for flight information, in response to said determining.
9. The method of example embodiment 8, wherein the network node is a base station serving the UE-equipped UAV, and wherein the request is sent to an Access and Mobility Management Function, AMF, in the wireless communication system.
10. The method of example embodiment 9, wherein determining that the flight information is needed is based on information reported to the base station by the UE-equipped UAV.
11. The method of example embodiment 10, wherein the information reported to the base station by the UE-equipped UAV comprises any one or more of any of:
   position information for the UE-equipped UAV;
   measurement information; and
   flight path information for the UE-equipped UAV.
12. The method of example embodiment 8, wherein the network node is an Access and Mobility Management Function, AMF, in the wireless communication system, wherein said determining that flight information is needed comprises receiving a request for said flight information from a base station serving the UE-equipped UAV, and wherein the network node sends the request for flight information to a network interworking function, for forwarding to the node external to the wireless communication system.
13. The method of example embodiment 8, wherein the network node is an Access and Mobility Management Function, AMF, in the wireless communication system, wherein said determining that flight information is needed comprises receiving a request for said flight information from a base station serving the UE-equipped UAV, and wherein the network node sends flight information already possessed by the network node to the base station, in response to the request.
14. The method of example embodiment 8, wherein the network node is a network interworking function in the wireless communication system, wherein said determining that flight information is needed comprises receiving a request for said flight information from an Access and Mobility Management Function, AMF, in the wireless communication system, and wherein the network node sends the request for flight information to the node external to the wireless communication system.
15. The method of example embodiment 8, wherein the method further comprises receiving, in response to the request, flight information for UAVs in the vicinity of the UE-equipped UAV.
16. The method of example embodiment 15, wherein the network node is a base station serving the UE-equipped UAV, and wherein the flight information is received from an Access and Mobility Management Function, AMF, in the wireless communication system.
17. The method of example embodiment 16, wherein the method comprises sending a change in configuration to the UE-equipped UAV, based on the flight information.
18. The method of example embodiment 17, wherein the change in configuration indicates a change in transmission or reception of detection and avoidance messages by the UE-equipped UAV.
19. The method of example embodiment 15, wherein the network node is an Access and Mobility Management Function, AMF, in the wireless communication system, wherein the flight information is received from a network interworking function, and wherein the method further comprises forwarding the flight information to a base station serving the UE-equipped UAV.
20. The method of example embodiment 15, wherein the network node is a network interworking function in the wireless communication system, wherein the flight information is received from the node external to the wireless communication system, and wherein the method further comprises forwarding the flight information to an Access and Mobility Management Function, AMF, in the wireless communication system.
21. The method of any of the previous embodiments, further comprising:
   obtaining user data; and
   forwarding the user data to a host or a user equipment.

### Group C Embodiments

22. A user equipment, comprising:
   processing circuitry configured to perform any of the steps of any of the Group A embodiments; and
   power supply circuitry configured to supply power to the processing circuitry.
23. A network node, comprising:
   processing circuitry configured to perform any of the steps of any of the Group B embodiments;
   power supply circuitry configured to supply power to the processing circuitry.
24. A user equipment (UE), the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
25. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to receive the user data from the host.
26. The host of the previous embodiment, wherein the cellular network further includes a network node configured to communicate with the UE to transmit the user data to the UE from the host.
27. The host of the previous 2 embodiments, wherein:
   the processing circuitry of the host is configured to execute a host application, thereby providing the user data; and
   the host application is configured to interact with a client application executing on the UE, the client application being associated with the host application.
28. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A embodiments to receive the user data from the host.
29. The method of the previous embodiment, further comprising:
   at the host, executing a host application associated with a client application executing on the UE to receive the user data from the UE.
30. The method of the previous embodiment, further comprising:
   at the host, transmitting input data to the client application executing on the UE, the input data being provided by executing the host application,
   wherein the user data is provided by the client application in response to the input data from the host application.
31. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to transmit the user data to the host.
32. The host of the previous embodiment, wherein the cellular network further includes a network node configured to communicate with the UE to transmit the user data from the UE to the host.
33. The host of the previous 2 embodiments, wherein:
   the processing circuitry of the host is configured to execute a host application, thereby providing the user data; and
   the host application is configured to interact with a client application executing on the UE, the client application being associated with the host application.
34. A method implemented by a host configured to operate in a communication system that further includes a network node and a user equipment (UE), the method comprising:
   at the host, receiving user data transmitted to the host via the network node by the UE, wherein the UE performs any of the steps of any of the Group A embodiments to transmit the user data to the host.
35. The method of the previous embodiment, further comprising:
   at the host, executing a host application associated with a client application executing on the UE to receive the user data from the UE.
36. The method of the previous embodiment, further comprising:
   at the host, transmitting input data to the client application executing on the UE, the input data being provided by executing the host application,
   wherein the user data is provided by the client application in response to the input data from the host application.
37. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
38. The host of the previous embodiment, wherein:
   the processing circuitry of the host is configured to execute a host application that provides the user data; and
   the UE comprises processing circuitry configured to execute a client application associated with the host application to receive the transmission of user data from the host.
39. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group B embodiments to transmit the user data from the host to the UE.
40. The method of the previous embodiment, further comprising, at the network node, transmitting the user data provided by the host for the UE.
41. The method of any of the previous 2 embodiments, wherein the user data is provided at the host by executing a host application that interacts with a client application executing on the UE, the client application being associated with the host application.
42. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
43. The communication system of the previous embodiment, further comprising:
   the network node; and/or
   the user equipment.
44. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
45. The host of the previous 2 embodiments, wherein:
   the processing circuitry of the host is configured to execute a host application, thereby providing the user data; and
   the host application is configured to interact with a client application executing on the UE, the client application being associated with the host application.
46. The host of the any of the previous 2 embodiments, wherein the initiating receipt of the user data comprises requesting the user data.
47. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
48. The method of the previous embodiment, further comprising at the network node, transmitting the received user data to the host.

### REFERENCES

1. M. Mozaffari, X. Lin, and S. Hayes, “Towards 6G with Connected Sky: UAVs and Beyond,” Online: 2103.01143.pdf (arxiv.org).

### ABBREVIATIONS

| Abbreviation | Explanation |
|---|---|
| AMF | Access and Mobility Management Function |
| CN | Core network |
| D/A | Detection and avoidance |
| DCI | Downlink control information |

1-29. (canceled)

30. A method, in a user equipment (UE) in a UE-equipped unmanned aerial vehicle (UAV), the method comprising:
determining that flight information for UAVs in the vicinity of the UE-equipped UAV is needed; and
sending, to a wireless communication system, a request for flight information, in response to said determining.

31. The method of claim 30, wherein said determining is based on one or more of any of:
the flight path of the UE-equipped UAV has changed;
a configured timer has expired;
a discovery signal sent by a neighbor drone is received;
the UE has been handed over;
interference measured by the UE has gone above a configured threshold; and
a channel quality measured by the UE has gone below a configured threshold.

32. The method of claim 30, wherein the request is sent towards an Access and Mobility Management Function (AMF), using non-access stratum (NAS) signaling.

33. The method of claim 30, further comprising:
receiving, in response to the request, flight information for UAVs in the vicinity of the UE-equipped UAV.

34. The method of claim 30, further comprising:
sending, to the wireless communications network, flight path information for the UE-equipped UAV.

35. The method of claim 34, wherein sending flight path information for the UE-equipped UAV is triggered by one or more of any of:
the flight path of the UE-equipped UAV has changed;
a configured timer has expired;
a discovery signal sent by a neighbor drone is received;
the UE has been handed over;
a request from the wireless communications network;
interference measured by the UE has gone above a configured threshold; and
a channel quality measured by the UE has gone below a configured threshold.

36. A method, in a network node of a wireless communication system, the method comprising:
determining that flight information for unmanned aerial vehicles (UAVs) in the vicinity of a UE-equipped UAV is needed; and
sending, towards a node external to the wireless communication system, a request for flight information, in response to said determining.

37. The method of claim 36, wherein the network node is a base station serving the UE-equipped UAV, and wherein the request is sent to an Access and Mobility Management Function (AMF) in the wireless communication system.

38. The method of claim 37, wherein determining that the flight information is needed is based on information reported to the base station by the UE-equipped UAV.

39. The method of claim 38, wherein the information reported to the base station by the UE-equipped UAV comprises any one or more of any of:
position information for the UE-equipped UAV;
measurement information; and
flight path information for the UE-equipped UAV.

40. The method of claim 36, wherein the network node is an Access and Mobility Management Function (AMF) in the wireless communication system, wherein said determining that flight information is needed comprises receiving a request for said flight information from a base station serving the UE-equipped UAV, and wherein the method comprises sending the request for flight information to a network interworking function, for forwarding to the node external to the wireless communication system.

41. The method of claim 36, wherein the network node is an Access and Mobility Management Function (AMF) in the wireless communication system, wherein said determining that flight information is needed comprises receiving a request for said flight information from a base station serving the UE-equipped UAV, and wherein the method comprises sending flight information already possessed by the network node to the base station, in response to the request.

42. The method of claim 36, wherein the network node is a network interworking function in the wireless communication system, wherein said determining that flight information is needed comprises receiving a request for said flight information from an Access and Mobility Management Function (AMF) in the wireless communication system, and wherein the method comprises sending the request for flight information to the node external to the wireless communication system.

43. The method of claim 36, wherein the method further comprises receiving, in response to the request, flight information for UAVs in the vicinity of the UE-equipped UAV.

44. The method of claim 43, wherein the network node is a base station serving the UE-equipped UAV, and wherein the flight information is received from an Access and Mobility Management Function (AMF) in the wireless communication system.

45. The method of claim 44, wherein the method comprises sending a change in configuration to the UE-equipped UAV, based on the flight information.

46. The method of claim 45, wherein the change in configuration indicates a change in transmission or reception of detection and avoidance messages by the UE-equipped UAV.

47. The method of claim 43, wherein the network node is an Access and Mobility Management Function (AMF) in the wireless communication system, wherein the flight information is received from a network interworking function, and wherein the method further comprises forwarding the flight information to a base station serving the UE-equipped UAV.

48. A user equipment (UE) for use in a UE-equipped unmanned aerial vehicle (UAV), and for communication with one or more network nodes and/or other UEs, the UE comprising radio circuitry and processing circuitry configured to:
determine that flight information for UAVs in the vicinity of the UE-equipped UAV is needed; and
send, to a wireless communication system, a request for flight information, in response to said determining.

49. The UE of claim 48, wherein said determining is based on one or more of any of:
the flight path of the UE-equipped UAV has changed;
a configured timer has expired;
a discovery signal sent by a neighbor drone is received;
the UE has been handed over;
interference measured by the UE has gone above a configured threshold; and
a channel quality measured by the UE has gone below a configured threshold.

50. A network node for communication with one or more nodes and/or user equipments, UEs, the network node comprising communication interface circuitry and processing circuitry configured to:
determine that flight information for unmanned aerial vehicles, UAVs, in the vicinity of a UE-equipped UAV is needed; and
send, towards a node external to the wireless communication system, a request for flight information, in response to said determining.

51. The network node according to claim 50, wherein the network node is a base station serving the UE-equipped UAV, and wherein the communication interface circuitry and processing circuitry are configured to send the request to an Access and Mobility Management Function (AMF) in the wireless communication system.
